(19) United States
(12) Patent Application Publication
(10) Pub. No.: US 2013/0159640 A1
(43) Pub. Date: Jun. 20, 2013

(54) SYSTEM AND METHOD OF READING AND WRITING OPERATING PARAMETERS AND DATA FOR A CONTROL DEVICE

(71) Applicant: Shanghai Kohler Electronics, Ltd., Shanghai (CN)

(72) Inventors: Jun Lu, Shanghai (CN); Zhongmin Chen, Shanghai (CN); Pengcheng Gao, Shanghai (CN)

(73) Assignee: Shanghai Kohler Electronics, Ltd., Shanghai (CN)

(21) Appl. No.: 13/715,880

(22) Filed: Dec. 14, 2012

(30) Foreign Application Priority Data
Dec. 16, 2011 (CN) 201110425519.0

(51) Int. Cl. G06F 12/00

(52) U.S. Cl. CPC G06F 12/00
USPC 711/154

(57) ABSTRACT

The present disclosure provides a system for reading and writing operating parameters and real-time data for a control device. The system includes a power source, and a read/write device powered by the power source, the read/write device configured to conduct modulation of the power supply voltage based on a predetermined encoding mode. The system also includes a control device powered by the read/write device, wherein operating parameters and data information are exchanged between the control device and the read/write device, and the control device is configured to conduct demodulation of an output voltage transmitted by the read/write device. The system further includes power lines electrically connecting the power source to the read/write device and the read/write device to the control device.

### CROSS-REFERENCE TO RELATED PATENT APPLICATIONS

The present application claims the benefit of and priority to Chinese Patent Application 201110425519.0, filed Dec. 16, 2011, the entire contents of which are hereby incorporated by reference in their entirety.

### TECHNICAL FIELD

The present disclosure relates to a system and method of reading and writing operating parameters and real-time data for a control device, and more particularly to a sensor faucet employing the described system and method.

### BACKGROUND

Sensors and controllers (i.e. control devices), and particularly sensor faucet controllers in bathroom products, often need to set related operating parameters prior to operation. These operating parameters may also need to be adjusted during operation. Examples of operating parameters include sensing distance, valve-open time, delay, electrified time, and sampling interval.

Conventional sensor and/or controller-related products typically use a process to set and adjust operating parameters. First, the products use a DIP switch to set operating parameters. DIP switches are often used in the control units of FM pairing, automated switch control, and pre-wired circuits in wireless communication devices. DIP switches are capable of controlling high-low power levels, playing a role similar to that of a single chip microprocessor. Second, the products extract a special interface from a related product to read and write operating parameters. This special interface is used to achieve parameter and data transmission between external devices and the sensor/controller. Third, the products multiplex the other control interfaces of the sensor/controller, enabling the multiplexed control interfaces to simultaneously transmit operating parameters while conducting their own control operations.

When using a DIP switch or special interface to read and/or write and set operating parameters, it is necessary to conduct equipment joining. Using these conventional processes, it may not be possible to ensure a waterproof seal at the joining site. For bathroom fixtures that come into contact with water, this is a problem.

Also, if other interfaces are multiplexed, the original control functions of the multiplexed control interfaces become limited. This has an adverse effect on the normal control operations of the sensor/controller.

### SUMMARY

An embodiment of the present disclosure relates to a system for reading and writing operating parameters and real-time data for a control device. The system includes a power source, and a read/write device powered by the power source, the read/write device configured to conduct modulation of the power supply voltage based on a predetermined encoding mode. The system also includes a control device powered by the read/write device, wherein operating parameters and data information are exchanged between the control device and the read/write device, and the control device is configured to conduct demodulation of an output voltage transmitted by the read/write device. The system further includes power lines electrically connecting the power source to the read/write device and the read/write device to the control device.

Another embodiment of the present disclosure relates to a sensor faucet. The sensor faucet includes a system for reading and writing operating parameters and real-time data for a sensor or controller. The system includes a power source, and a read/write device powered by the power source, the read/write device configured to conduct modulation of the power supply voltage based on a predetermined encoding mode. The system also includes a control device powered by the read/write device, wherein operating parameters and data information are exchanged between the control device and the read/write device, and the control device is configured to conduct demodulation of an output voltage transmitted by the read/write device. The system further includes power lines electrically connecting the power source to the read/write device and the read/write device to the control device.

Another embodiment of the present disclosure relates to a method for reading and writing the operating parameters and real-time data of a control device. The method includes providing a power source, powering a read/write device with the power source, and causing the read/write device to conduct modulation of the power supply voltage based on a predetermined encoding mode. The method also includes powering a control device by the read/write device, and causing the control device and the read/write device to exchange operating parameters and data information, and to conduct demodulation of an output voltage transmitted by the read/write device. The method further includes providing from the power source by one or more power lines.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a system block diagram of a sensing system (e.g., a faucet having a powered motion sensing feature) for using power lines to read and write sensor/controller operating parameters and real-time data, according to an exemplary embodiment.

FIG. 2 is a circuit diagram of the read/write device and sensor/controller of the present disclosure, according to an exemplary embodiment.

FIG. 3 is a current testing circuit schematic for a ZXCT1009F integrated circuit chip, according to an exemplary embodiment.

FIG. 4 is a diagram of a data transfer format of various systems and methods of the present disclosure, according to an exemplary embodiment.

### DETAILED DESCRIPTION OF THE PREFERRED EMBODIMENTS

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

The read/write device of the present disclosure is configured to use power lines to read and write sensor/controller operating parameters and real-time data. The read/write device may not require an additional read/write communication interface, and may not be required to conduct multiplexing of the original control interfaces in the sensor/controller.

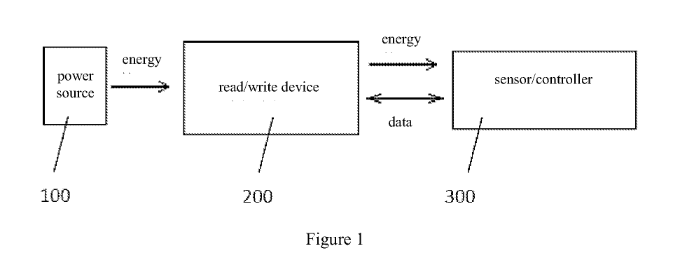

FIG. 1 is a system block diagram of a system for using power lines to read and write sensor/controller operating parameters and real-time data, according to an exemplary embodiment. As shown in FIG. 1, a power source 100 provides a read/write device 200 with power (i.e. energy). The read/write device 200 conducts modulation of the power source 100's output power supply voltage based on a predetermined encoding mode. The read/write device 200 then provides a sensor/controller 300 (i.e. control device) with power and conducts an exchange of operating parameters and real-time data with the sensor/controller 300. This exchange of parameters and other data enables the sensor/controller 300 to conduct a demodulation of the power supply voltage transmitted by the read/write device 200. Thus, data is transmitted from the read/write device 200 to the sensor/controller 300, and the data is used to control the sensor/controller. At the same time, the sensor/controller 300 may also send data related to the operating parameters back to the read/write device 200, enabling the read/write device 200 to make adjustments to these operating parameters. Power lines may be used for the electrical connections between the power source 100 and read/write device 200 and between the read/write device 200 and sensor/controller 300. In exemplary embodiments, the memory in the sensor/controller 300 (e.g. non-volatile memory, etc.) can store data related to the operating parameters.

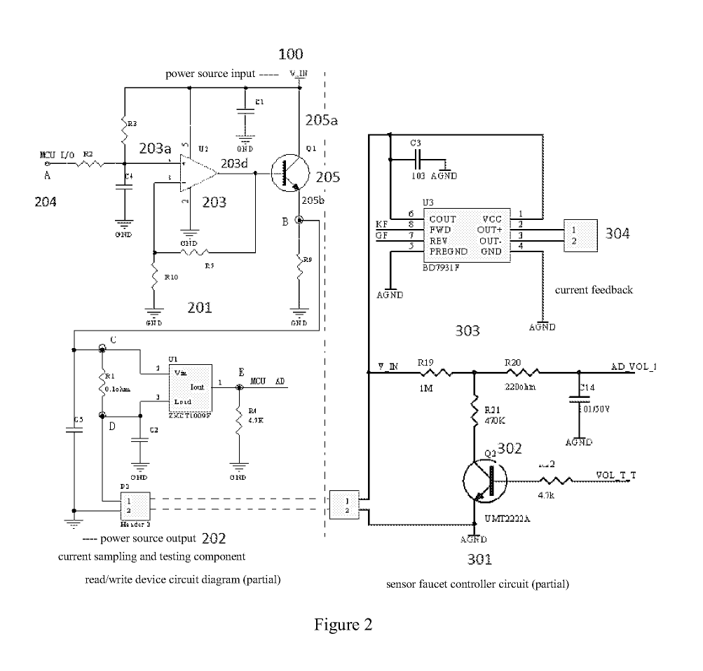

FIG. 2 is a circuit diagram of the read/write device 200 and sensor/controller 300, according to an exemplary embodiment. The read/write device 200 includes a voltage modulation component 201 and a current sampling and testing component 202. The voltage modulation component 201 controls the voltage output to the sensor/controller 300, and causes the output voltage to carry a data signal. The current sampling and testing component 202 obtains the data information transmitted back by the sensor/controller 300 based on the change patterns of the power supply current.

As shown in FIG. 2, the voltage modulation component 201 includes an in-phase input terminal 203a of an operational amplifier 203 that is connected to the power source 100 by a resistor R3. The voltage modulation component 201 also includes an output terminal 203d of the operational amplifier 203 that is connected to the base electrode of an emitter follower 205. The voltage modulation component includes an emitter electrode 205b of the emitter follower 205 providing a voltage output to the sensor/controller 300. A collector electrode 205a of the emitter follower 205 is electrically connected to the power source 100. Further, the voltage modulation component 201 includes a micro-control unit (MCU) 204 connected to the operational amplifier 203's in-phase input terminal 203a by resistor R2.

The micro-control unit 204 controls its output level based on a set of encoding rules. In exemplary embodiments, it is possible to control the output voltage through the operational amplifier 203 and emitter follower 205, causing the output voltage of the emitter electrode 205b to generate small fluctuations, and thus enabling the read/write device 200 to provide a data output signal while providing the sensor/controller 300 with power.

For instance, the output voltage of the power source 100 may be set as V. When the micro-control unit 204 emits high power level V_{H}, resistors R2 and R3 positioned between the power source 100 and micro-control unit 204 form divided voltage. Thus, the voltage at the normal phase input terminal 203a of the operational amplifier 203 (i.e. the connection points of resistors R2 and R3) is equal to (V_{IN}−V_{H})R2/(R2+R3)+V_{H}. This voltage is also the voltage of the emitter follower 205's base electrode. As a result, the emitter follower 205 operates in a saturation mode, and the collector electrode 205a and emitter electrode 205b approach a connection. Therefore, the voltages of the collector electrode 205a and emitter electrode 205b are nearly equal, or the voltage at emitter electrode 205b V_{B}≈V_{IN}. In addition, when the micro-control unit 204 emits low power (e.g. V_{L}=0), the voltage of the normal phase input terminal of the operational amplifier 203 drops to V_{IN}×R2/(R2+R3), which is also the emitter follower's 205 base electrode voltage. This drop in the base electrode voltage causes the emitter follower 205 to operate in follow mode, causing the emitter electrode 205b voltage V_{B} to be lower than the collector electrode 205a voltage V. The specific relationship described can be shown as V_{B}=0.8V_{IN}.

When the micro-control unit 204 emits a series of high and low power levels, the output voltage from the read/write device 200 to the sensor/controller 300 will generate corresponding small fluctuations in the voltage modulation component 201. When the micro-control unit 204 emits high power, the output voltage will be roughly 100 percent of the total power supply voltage of the power source 100. When the micro-control unit 204 emits low power, the output voltage will be roughly 80 percent of the total power supply voltage of the power source 100.

The sensor/controller 300 may be equipped with a voltage sampling circuit 301, conducting sampling and analog-digital conversion of the output voltage coming from the read/write device 200. In the voltage sampling circuit 301, the output voltage is connected to the emitter follower 302's collector electrode through resistors R19 and R21, and the emitter electrode of the emitter follower 302 is grounded. The voltage at the connection point of resistors R19 and R21 is observed. When the emitter follower 302 is connected, the observed voltages at the connection points of resistors R19 and R21 are termed the divided voltage values of resistors R19 and R21. It is possible to send these divided voltage values directly to another micro-control unit for analog-digital conversion, thus obtaining the voltage fluctuation signal. Then decoding is conducted based on the encoding rules, and the information transmitted from the read/write device 200 is obtained by the sensor/controller 300 for conducting corresponding operations.

The sensor/controller 300 is configured to transmit data related to operating parameters back to the read/write device 200, enabling the read/write device 200 to make adjustments to these operating parameters. This being the case, the sensor/controller 300 is equipped with a current feedback component 303. In the current feedback component 303, a power device 304 (e.g. an electromagnetic valve coil, an LED indicator light, or an infrared emitting diode, etc.) is regularly controlled based on the encoding mode and data content, regularly monitoring and changing the power supply current.

The current feedback component 303 uses power lines to feed the current back to the current sampling and testing component 202 of the read/write device 200. When the power device 304 is running (e.g. when the electromagnetic coil is electrified or the infrared emitting diode is emitting infrared rays, etc.), the current of the sensor/controller 300 will be amplified. At the same time, the voltage at the external resistor R1 of the current sampling and testing component 202 will be amplified, and correspondingly, the output current of the ZXCT1009F integrated circuit chip in the current sampling and testing component 202 will be amplified. The voltage reflected at output resistor R4 will also be amplified. Conversely, when the power device 304 is not running (e.g. when the electromagnetic coil is not electrified or the infrared emitting diode is not emitting infrared rays, etc.), the voltage reflected at output resistor R4 of the current sampling and testing component 202 will drop. In the read/write device 200, the device may determine the change in the current through the current sampling and testing component 202. After decoding by the micro-control unit, the data information transmitted by the sensor/controller 300 is obtained for use (e.g., data processing).

In FIG. 2, the current sampling and testing component 202 uses a ZXCT1009F integrated circuit chip to conduct current sampling and testing. The ZXCT1009F integrated circuit chip is a current sensor and monitor chip produced by Zetex Corporation. It is small and has simple peripheral circuits. It has a voltage output range of 2.5-20 volts. The output voltage is adjustable, its static current is just 0.5 microamperes, and its precision is 1 percent.

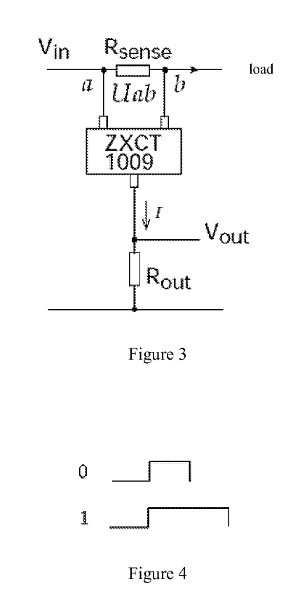

FIG. 3 is a current testing circuit schematic for the ZXCT1009F integrated circuit chip. A sampling resistor Rsense is externally connected to the input terminal of the ZXCT1009F integrated circuit chip. The voltages Uab at the two terminals of the sampling resistor Rsense can be converted into current I of the output terminal. The conversion relationship between voltage Uab and current I is shown in the following table:

| Uab | | I | |
|---|---|---|---|
| 0 | V | 4 | μA |
| 10 | mV | 104 | μA |
| 100 | mV | 1.002 | mA |
| 200 | mV | 2.0 | mA |
| 1 | V | 9.98 | mA |

As shown in FIG. 3, at its output terminal, the ZXCT1009F integrated circuit chip is externally connected to an output resistor Rout. The output current I flows through the output resistor Rout and generates voltage Vout. Vout is an analog signal, and this analog signal can be digitized for use by the micro-control unit following analog-digital conversion.

The data transfer formats of the present disclosure are not limited to a specific format. The data transfer formats can be defined according to actual use. For example, the present disclosure may employ a data definition format as shown in FIG. 4 to conduct a data transfer. As shown in FIG. 4, when sending “0”, the high and low power level widths are the same. When sending “1”, the high power level width is twice the width of the low power level. This format can effectively overcome the clock errors of the read/write device 200 and the sensor/controller 300, boosting communication reliability.

The system of the present disclosure uses power lines to read and write sensor/controller operating parameters and real-time data. The system of the present disclosure does not employ an extra DIP switch or special lead wire interface at the sensing faucet itself. Therefore, it is not necessary to conduct special waterproof sealing. In addition, for similar products such as bathroom products, it is possible to use the system of the present disclosure to set factory settings and make on-site modifications to the operating parameters.

What is claimed is:

1. A system for reading and writing operating parameters and real-time data for a control device, the system comprising:
a power source;
a read/write device powered by the power source, the read/write device configured to conduct modulation of the power supply voltage based on a predetermined encoding mode;
a control device powered by the read/write device, wherein operating parameters and data information are exchanged between the control device and the read/write device, and the control device is configured to conduct demodulation of an output voltage transmitted by the read/write device; and
power lines electrically connecting the power source to the read/write device and the read/write device to the control device.

2. The system of claim 1, further comprising memory installed in the control device, the memory used to store data related to the operating parameters.

3. The system of claim 2, wherein the memory is non-volatile memory.

4. The system of claim 1, wherein the read/write device comprises a voltage modulation component and a current sampling and testing component, the voltage modulation component configured to provide the output voltage to the control device and to cause the output voltage to carry a data signal, and the current sampling and testing component configured to obtain the data information transmitted by the control device based on the change patterns of the power supply current.

5. The system of claim 4, wherein the voltage modulation component comprises:
a first micro-control unit;
an operational amplifier, wherein an in-phase input terminal of the operational amplifier is connected to the first micro-control unit by a first resistor and is connected to the power source by a second resistor; and
a first emitter follower, wherein a base electrode of the first emitter follower is connected to an output terminal of the operational amplifier, a collector electrode of the first emitter follower is connected to the power source, and an emitter electrode of the first emitter follower generates output voltage to supply the control with power.

6. The system of claim 5, wherein a voltage sampling circuit is installed in the control device, the voltage sampling circuit conducting sampling and analog-digital conversion of the output voltage.

7. The system of claim 6, wherein the output voltage in the voltage sampling circuit is connected to a collector electrode of a second emitter follower through a third and fourth resistor, the emitter electrode of the second emitter follower being grounded, the voltages at the connection points of the third and fourth resistors being divided voltage values of the third and fourth resistors when the second emitter follower is connected, and these divided voltage values are transmitted to another micro-control unit for analog-digital conversion, thus obtaining the voltage fluctuation signal, and then conducting demodulation based on the encoding rules and obtaining the information transmitted from the read/write device.

8. The system of claim 7, wherein the control device further comprises a current feedback component configured to send data related to the operating parameters back to the read/write device, wherein a power device is regularly controlled within the current feedback component based on the encoding mode and data content in order to achieve regular changes in the power supply current.

9. The system of claim 8, wherein the power device is one of an electromagnetic valve coil, an LED indicator light, or an infrared emitting diode.

10. The system of claim 4, wherein the current sampling and testing component includes a ZXCT1009F integrated circuit chip for current sampling and testing.

11. A sensor faucet, comprising:
a system for reading and writing operating parameters and real-time data for a sensor or controller, the system comprising:
a power source;
a read/write device powered by the power source, the read/write device configured to conduct modulation of the power supply voltage based on a predetermined encoding mode;
a control device powered by the read/write device, wherein operating parameters and data information are exchanged between the control device and the read/write device, and the control device is configured to conduct demodulation of an output voltage transmitted by the read/write device; and
power lines electrically connecting the power source to the read/write device and the read/write device to the control device.

12. The sensor faucet of claim 1, the system further comprising memory installed in the control device, the memory used to store data related to the operating parameters.

13. The sensor faucet of claim 12, wherein the memory is non-volatile memory.

14. The sensor faucet of claim 11, wherein the read/write device comprises a voltage modulation component and a current sampling and testing component, the voltage modulation component configured to provide the output voltage to the control device and to cause the output voltage to carry a data signal, and the current sampling and testing component configured to obtain the data information transmitted by the control device based on the change patterns of the power supply current.

15. The sensor faucet of claim 14, wherein the voltage modulation component comprises:
a first micro-control unit;
an operational amplifier, wherein an in-phase input terminal of the operational amplifier is connected to the first micro-control unit by a first resistor and is connected to the power source by a second resistor; and
a first emitter follower, wherein a base electrode of the first emitter follower is connected to an output terminal of the operational amplifier, a collector electrode of the first emitter follower is connected to the power source, and an emitter electrode of the first emitter follower generates output voltage to supply the control with power.

16. The sensor faucet of claim 15, wherein a voltage sampling circuit is installed in the control device, the voltage sampling circuit conducting sampling and analog-digital conversion of the output voltage.

17. The sensor faucet of claim 16, wherein the output voltage in the voltage sampling circuit is connected to a collector electrode of a second emitter follower through a third and fourth resistor, the emitter electrode of the second emitter follower being grounded, the voltages at the connection points of the third and fourth resistors being divided voltage values of the third and fourth resistors when the second emitter follower is connected, and these divided voltage values are transmitted to another micro-control unit for analog-digital conversion, thus obtaining the voltage fluctuation signal, and then conducting demodulation based on the encoding rules and obtaining the information transmitted from the read/write device.

18. The sensor faucet of claim 17, wherein the control device further comprises a current feedback component configured to send data related to the operating parameters back to the read/write device, wherein a power device is regularly controlled within the current feedback component based on the encoding mode and data content in order to achieve regular changes in the power supply current.

19. A method for reading and writing the operating parameters and real-time data of a control device, the method comprising:
providing a power source;
powering a read/write device with the power source;
causing the read/write device to conduct modulation of the power supply voltage based on a predetermined encoding mode;
powering a control device by the read/write device;
causing the control device and the read/write device to exchange operating parameters and data information, and to conduct demodulation of an output voltage transmitted by the read/write device; and
providing from the power source by one or more power lines.

20. The method of claim 19, further comprising:
providing a voltage modulation component and a current sampling and testing component within the read/write device,
causing the voltage modulation component to provide the output voltage to the control device;
causing the output voltage to carry a data signal; and
obtaining the data information transmitted by the control device based on the change patterns of the power supply current.
